(19) United States
(12) Patent Application Publication
(10) Pub. No.: US 2010/0143026 A1
(43) Pub. Date: Jun. 10, 2010

(54) FIXING MECHANISM AND ELECTRONIC DEVICE USING THE SAME

(75) Inventor: ZI-MING TANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/492,395

(22) Filed: Jun. 26, 2009

(30) Foreign Application Priority Data
Dec. 5, 2008 (CN) 200810305999.5

(51) Int. Cl. F16B 7/18

(52) U.S. Cl. 403/200

(57) ABSTRACT

A fixing mechanism includes an engaging member and a cover received in the engaging member. The engaging member forms a first threaded portion and a restricting portion. The cover forms a second threaded portion and a latching portion. The first threaded portion engages the second threaded portion, so that the cover is fixed to the engaging member. The latching portion engages the restricting portion, so that the cover is positioned in a fixed final position of the engaging member. The fixing mechanism fixes components stably and conveniently to position the cover on the engaging member.

### BACKGROUND

1. Technical Field

The present disclosure generally relates to battery fittings for electronic devices, and particularly, to a fixing mechanism for a battery and an electronic device using the same.

2. Description of Related Art

Keyboards as input devices of computers include both wired and wireless types. Wireless keyboards are widely used because of its flexibility. A typical wireless keyboard includes an emitter and one or more batteries providing power. A fixing mechanism fixes the batteries in the wireless keyboard.

A typical fixing mechanism for a battery in a main body of a wireless keyboard includes a sleeve formed on an end of the keyboard receiving the battery and a cover retaining the battery in the sleeve. An inner wall of the sleeve forms a first threaded portion. The cover is substantially cylindrical. The cylindrical surface of the cover forms a second threaded portion. The first threaded portion engages the second threaded portion, thereby fixing the cover in the main body to hold the battery in the sleeve.

However, the first threaded portion and the second threaded portion wear easily from repeated engagements. When the first threaded portion and the second threaded portion experience such wear, the cover cannot be positioned in the sleeve to fix the battery in the sleeve stably to ensure proper battery function.

Therefore, a fixing mechanism and an electronic device using the same are desired to overcome the described limitations.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an exploded, isometric view of an embodiment of an electronic device and an embodiment of a fixing mechanism employed in the electronic device.

FIG. 2 is an isometric view of a main body of the electronic device in FIG. 1.

FIG. 3 is a partial cutaway view of the electronic device in FIG. 1.

### DETAILED DESCRIPTION

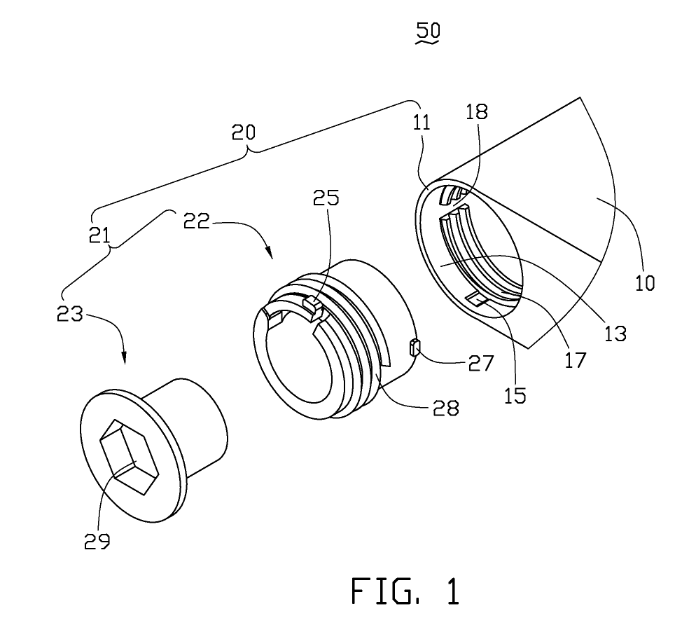

Referring to FIG. 1, an electronic device 50 includes a main body 10 and a fixing mechanism 20, positioned in the main body 10. The fixing mechanism 20 includes an engaging member 11 formed on an end of the main body 10 and a cover 21 received in the engaging member 11. In the illustrated embodiment, the main body 10 is a wireless keyboard, and the engaging member 11 is a sleeve. The cover 21 retains the battery (not shown) in the engaging member 11.

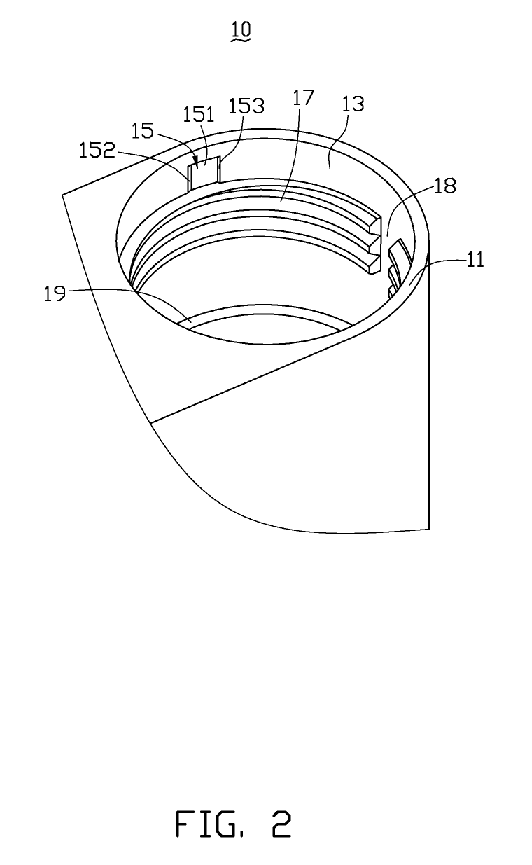

Referring also to FIG. 2, the main body 10 may be substantially rectangular. The engaging member 11 has an inner wall 13 and includes a restricting portion 15, a first threaded portion 17, a guiding portion 18, and a stepped portion 19 formed on the inner wall 13. In the illustrated embodiment, the restricting portion 15 is a restricting slot, enclosed by a bottom sidewall 151, a first sidewall 152, and a second sidewall 153 facing the first sidewall 152. The restricting portion 15, the first threaded portion 17 and the stepped portion 19 are arranged from an edge to an inside of the inner wall 13. The guiding portion 18 is a slot, and the first threaded portion 17 is segmented thereby.

The cover 21 includes a fixing member 22 and an operating member 23. The operating member 23 may be adhered to the fixing member 22 by glue. The fixing member 22 may be metal, and the operating member 23 may be plastic. The fixing member 22 is substantially cylindrical. The fixing member 22 includes a latching portion 25 engaging the restricting portion 15 formed on one end of the fixing member 22, a positioning portion 27 to engage with the guiding portion 18 formed on the other end of the fixing member 22, and a second threaded portion 28 to engage with the first threaded portion 17. The second threaded portion 28 is disposed between the restricting portion 25 and the positioning portion 27. The surface of the first sidewall 152 is arcuate, so that the restricting portion 25 of the cover 20 can easily slide out of the restricting portion 15 from the first sidewall. The surface of the second sidewall 153 is planar and the second sidewall 153 is substantially perpendicular to the bottom sidewall 151, so that the latching portion 25 of the cover 21 cannot slide out of the restricting portion 15 from the second sidewall 153. In the illustrated embodiment, the latching portion 25 is an elastic protrusion, and the positioning portion 27 is a projection. An end surface of the operating member 23 defines a tooling hole 29 to receive a tool to facilitate operation of the operating member 23.

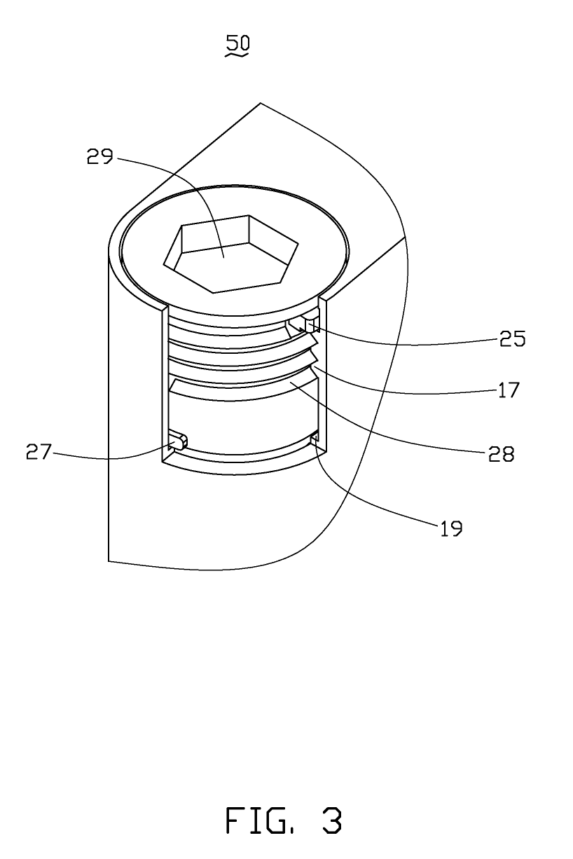

Referring also to FIG. 3, during assembly of the electronic device 50, one or more batteries (not shown) can be mounted in the engaging member 11 of the fixing mechanism 20. The cover 21 engages with the engaging member 11 by aligning the positioning portion 27 with the guiding portion 18. When the positioning portion 27 passes through the first threaded portion 17, the fixing member 22 is rotated to engage the second threaded portion 28 of the cover 21 with the first threaded portion 17 of the main body 10. The latching portion 25 is then compressed. When the positioning portion 27 resists the stepped portion 19 of the engaging member 11, the latching portion 25 rebounds and latches in the restricting portion 15. The battery contacts the fixing member 22. As such, the electronic device 50 is assembled. For opening the cover 21, a tool is received in the tooling hole 29 and the cover 21 is rotated to let the latching portion 25 slide out from the arcuate surface of the restricting portion 15.

The cover 21 can be fixed stably into the engaging member 11 with the latching portion 25 latched with the restricting portion 15, even if the first threaded portion 17 and the second threaded portion 28 are worn. Therefore, the fixing mechanism 20 may fix components stably while being convenient in positioning the cover 21 on the engaging member 11 to stop the fixing member 22 from resisting the battery to allow power to be provided. Furthermore, with the positioning portion 27 resisting the stepped portion 19 of the engaging member 11, the cover 21 can be restricted in the engaging member 11 stably. In addition, engagement of the positioning portion 27 and the guiding portion 18 facilitates engaging the first threaded portion 17 with the second threaded portion 28.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

1. A fixing mechanism, comprising:
an engaging member, forming a first threaded portion and a restricting portion; and
a cover received in the engaging member, the cover forming a second threaded portion engaging with the first threaded portion and a latching portion;
wherein the cover is positioned on the engaging member when the first threaded portion engages with the second threaded portion, the cover is received in the engaging member, with the latching portion engaging with the restricting portion.

2. The fixing mechanism of claim 1, wherein the engaging member further forms a guiding portion; the cover further forms a positioning portion engaging with the guiding portion to facilitate engaging the first threaded portion with the second threaded portion.

3. The fixing mechanism of claim 1, wherein the engaging member is a sleeve; the restricting portion, the first threaded portion and the guiding portion are formed on the inner wall of the sleeve.

4. The fixing mechanism of claim 3, wherein the restricting portion is a restricting slot; the latching portion is an elastic protrusion.

5. The fixing mechanism of claim 4, wherein the guiding portion is a guiding slot; the positioning portion is a projection; the first threaded portion is segmented by the guiding slot.

6. The fixing mechanism of claim 5, wherein the projection, the second threaded portion and the elastic protrusion engage with the guiding slot, the first threaded portion, and the restricting slot formed on the sleeve, respectively.

7. The fixing mechanism of claim 6, wherein the sleeve further forms a stepped portion; the positioning portion resists the stepped portion when the latching portion latches in the restricting portion.

8. The fixing mechanism of claim 7, wherein the restricting slot, the first threaded portion, and the stepped portion are arranged from an edge to an inside of the inner wall, in that order.

9. The fixing mechanism of claim 4, wherein the restricting slot is enclosed by a bottom sidewall, a first sidewall, and a second sidewall facing the first sidewall, the second sidewall is substantially perpendicular to the bottom sidewall.

10. The fixing mechanism of claim 9, wherein the surface of the first sidewall is arcuate.

11. An electronic device, comprising:
a main body; and
a fixing mechanism, the fixing mechanism comprising:
an engaging member, forming a first threaded portion and a restricting portion; and
a cover received in the engaging member, the cover forming a second threaded portion engaging with the first threaded portion and a latching portion;
wherein the cover is positioned on the engaging member when the first threaded portion engages with the second threaded portion, the cover is received in the engaging member, with the latching portion engaging with the restricting portion.

12. The electronic device of claim 11, wherein the engaging member further forms a guiding portion; the cover further forms a positioning portion engaging with the guiding portion to facilitate engaging the first threaded portion with the second threaded portion.

13. The electronic device of claim 12, wherein the engaging member is a sleeve, the first threaded portion and the guiding portion are formed on the inner wall of which the restricting portion.

14. The electronic device of claim 13, wherein the restricting portion is a restricting slot; the latching portion is an elastic protrusion.

15. The electronic device of claim 14, wherein the guiding portion is a slot, the positioning portion is a projection; the first threaded portion is segmented by the guiding slot.

16. The electronic device of claim 15 wherein the projection, the second threaded portion and the elastic protrusion engage with the guiding slot, the first threaded portion and the restricting slot formed on the sleeve, respectively.

17. The electronic device of claim 16, wherein the sleeve further forms a stepped portion; the positioning portion resists the stepped portion when the latching portion is in the restricting form.

18. The electronic device of claim 14, wherein the restricting slot, the first threaded portion, and the stepped portion are arranged from an edge to an inside of the inner wall, in that order.
